(19) United States
(12) Patent Application Publication
(10) Pub. No.: US 2003/0224765 A1
(43) Pub. Date: Dec. 4, 2003

(54) Data processing apparatus, terminal device, and data processing system

(76) Inventors: Hiroshi Udagawa, Tokyo (JP); Tsuyoshi Ide, Kanagawa (JP)

Correspondence Address: Robert J. Depke, Holland & Knight LLC, Suite 800, 55 West Monroe Street, Chicago, IL, 60603-5144, US

(21) Appl. No.: 10/373,477

(22) Filed: Feb. 24, 2003

(30) Foreign Application Priority Data
Feb. 25, 2002 (JP) JP2002-047288

(51) Int. Cl. H04Q 7/20

(52) U.S. Cl. 455/414.1; 455/66.1

(57) ABSTRACT

A data processing system according to the present invention includes a terminal device and a data processing apparatus for performing processing requested from the terminal device. The terminal device outputs a text file including descriptions of requested processing and parameters required for performing the processing to the data processing apparatus. The data processing apparatus receives the text file sent from the terminal device and performs the processing written in the text file.

### BACKGROUND OF THE INVENTION

1. Field of the Invention

The present invention relates to data processing apparatuses, terminal devices, and data processing systems and is applicable, for example, to systems that print images or the like in accordance with requests from mobile phones.

2. Description of the Related Art

Conventionally, various types of data equipment such as computers or the like connected to servers via a network launch software modules installed on the servers and make the servers perform particular processing based on a remote procedure call (RPC), JAVA (registered trademark) remote method invocation (RMI), Common Object Request Broker (CORBA) (registered trademark), or the like.

Also, the various types of data equipment make the servers perform particular processing based on a hyper text transfer protocol (http) by a computer graphics interface (CGI) installed on the servers.

It is convenient if various terminal devices such as mobile phones, personal digital assistants (PDAs) which are connected to servers or the like are also capable of making the servers or the like perform various types of processing. More specifically, for example, since some mobile phones have an imaging function, requesting the servers or the like to print images that are obtained by the imaging function may further improve the usability of the mobile phones. Moreover, since some mobile phones are capable of being connected to the Internet, it may also be possible to request the servers or the like to print images that are obtained via the Internet, instead of requesting to print the images that are obtained by the imaging function.

Use of RPC, JAVA RMI, CORBA, or the like, which is used when requesting for servers to perform processing, may enable such requests from the various terminal devices to be readily achieved.

For using RPC, JAVA RMI, CORBA, or the like, however, special programs must be installed on both the servers and clients. Since the various terminal devices have a limited processing capacity, a limited memory resource, and the like, such special programs cannot be readily installed on the terminal devices. Thus, it is difficult for the terminal devices to request the servers to perform the processing.

Since http is an upper-layer protocol of a transmission control protocol/internet protocol (TCP/IP), which is a transmission protocol, the TCP/IP protocol must be installed for a request based on http to perform various types of processing. For using http, it is also difficult for the terminal devices with a limited processing capacity, a limited memory resource, and the like to request servers to perform processing. In addition, for use of RPC, JAVA RMI, CORBA, or the like, such a transmission protocol must be installed.

### SUMMARY OF THE INVENTION

Accordingly, it is an object of the present invention to provide a data processing system in which various types of processing can be requested from a terminal device with a limited processing capacity, a limited memory resource, and the like to a data processing apparatus, the data processing system including the data processing apparatus and the terminal device.

In order to achieve the above object, a data processing apparatus according to the present invention includes a text file obtaining unit for obtaining a text file supplied from a terminal device; an analyzing unit for analyzing the text file; and a service execution unit for performing processing requested from the terminal device, in accordance with the analysis results by the analyzing unit.

With the arrangement described above, by simply creating and supplying the text file including details of requested processing, the terminal device is capable of requesting various types of processing. The text file can be transferred merely by a file transfer protocol. The text file can be transferred via any kind of data transmission, regardless of being wired or wireless communication. Thus, by even using a terminal device with a limited processing capacity, a limited memory resource, and the like, a text file can be sent to the data processing apparatus. Therefore, such a terminal device is capable of requesting various types of processing.

A terminal device according to the present invention includes a text file creation unit for creating a text file including a description of processing requested to an external data processing apparatus, in accordance with operation by a user, and a text file providing unit for providing the text file to the external data processing apparatus.

With the arrangement described above, the terminal device includes the text file creation unit for creating the text file including a description of processing requested to the external data processing apparatus, in accordance with operation by a user, and requests the external data processing apparatus to perform the processing written in the text file by supplying the text file. Thus, a terminal device even with a limited memory resource and the like is capable of requesting various types of processing.

A data processing system according to the present invention includes a terminal device and a data processing apparatus for performing processing requested from the terminal device. The terminal device sends a text file including a description of requested processing to the data processing apparatus, and the data processing apparatus receives the text file from the terminal device and performs the processing written in the text file.

With the arrangement described above, the data processing system is formed by the above-described data processing apparatus and terminal device.

### BRIEF DESCRIPTION OF THE DRAWINGS

FIG. 1 is a block diagram of a printing system according to an embodiment of the present invention; and

FIG. 2 is a plan view of an example of a text file used in the printing system in FIG. 1.

### DESCRIPTION OF THE PREFERRED EMBODIMENTS

The embodiments of the present invention will be described with reference to the drawings.

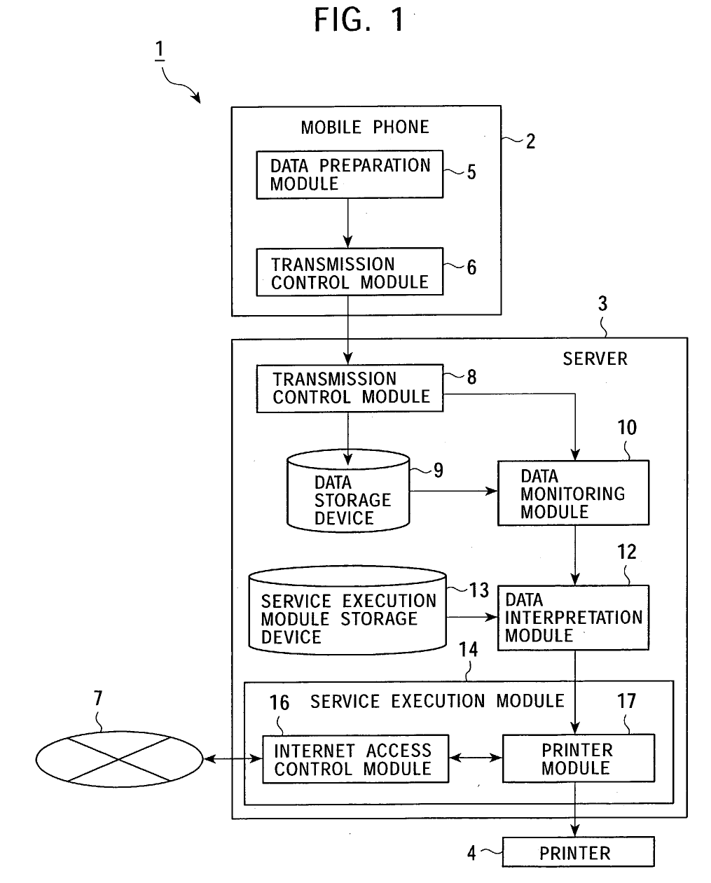

FIG. 1 is a block diagram showing a printing system 1 functioning as a data processing system according to an embodiment of the present invention. In the printing system 1, a server 3 receives processing requests for obtaining and printing various types of content from a mobile phone 2, and a printer 4 prints the content. Here, the content is various types of printable data. The printing system 1 obtains the content via the Internet and prints it. In the description below, a module represents a functional block for performing an assigned process.

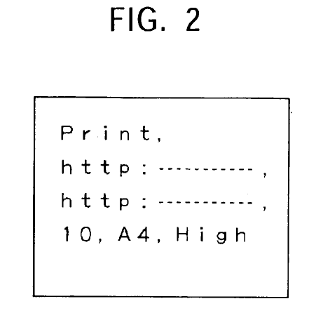

The mobile phone 2 is a portable terminal device. The mobile phone 2 allows a user to talk with a desired person via a telephone line for a mobile phone by controlling operation elements, as in commonly used mobile phones. Furthermore, the mobile phone 2 is, for example, capable of data communication with the server 3 based on Bluetooth (registered trademark), which is one type of wireless communication. By controlling the operation elements, the various types of data are transferred between the mobile phone 2 and the server 3 based on Bluetooth. The mobile phone 2 includes a character inputting module. Controlling a predetermined operation element launches a data preparation module 5. Then, characters input through the character inputting module are sent to the data preparation module 5 by controlling the operation element. The data preparation module 5 is, for example, a software module. A processing request to the server 3 is created as a text file in a predetermined format by such character input. FIG. 2 is a plan view showing a printed text file created in such a manner.

The text file is a normal text file whose extension is represented by “.TXT”. The text file includes a description of requested processing. In the text file, a character string “Print” is shown, which is the description of the processing. After the description of the processing, parameters required for performing the processing are assigned. In this embodiment, the parameters are assigned as follows: “http: . . . ” for a uniform resource locator (URL) showing an address of content to be printed, “http: . . . ” for a URL showing the printer 4 for performing the processing, “10” for the number of copies to be printed, “A4” for the size of the sheet to be printed, and “High” for the quality of printing. In the text file, the descriptions of the requested processing and each of the parameters are individually delimited by a predetermined character. In this embodiment, the character “,” is used as a delimiter.

The data preparation module 5 displays a message on the display screen of the mobile phone 2 to prompt the user to input such predetermined items and receives input from the user. The data preparation module 5 supplies the created text file to a transmission control module 6 in accordance with control of the operation element by the user.

The transmission control module 6 includes a data communication unit for data communication with the server 3, a control module for controlling the data communication unit, and a driver module. In this embodiment, a series of hardware and software modules according to Bluetooth communication are used. The transmission control module 6 receives the text file from the data preparation module 5 to transfer it to the server 3.

In this embodiment with the arrangement described above, the data preparation module 5 functions as a text file creation unit for creating a text file including descriptions of processing requested to the server 3, which is an external data processing apparatus, and parameters required for performing the processing, in accordance with operation by the user, and the transmission control module 6 functions as a text file providing unit for providing the text file to the server 3.

The server 3 is a computer connected to the printer 4. The server 3 receives the processing request in the form of a text file from the mobile phone 2 and performs the requested processing. More specifically, the server 3 accesses a homepage specified by the requested URL through the Internet 7 and obtains an image and text in the homepage as content to be printed. The printer 4 is activated by the server 3 to print the obtained content.

More specifically, a transmission control module 8 in the server 3 includes a data communication unit, a control module for controlling the data communication unit, and a driver module and they correspond to the data communication unit, the control module, and the driver module, respectively, in the transmission control module 6 in the mobile phone 2. The transmission control module 8 receives the text file from the transmission control module 6, stores the text file into a data storage device 9, and reports the reception of the text file to a data monitoring module 10.

The data storage device 9 is a mass storage device such as a hard disc drive used in this embodiment. The data storage device 9 holds the recorded text file input from the transmission control module 6 and then outputs the text file to the data monitoring module 10 upon a request from the data monitoring module 10.

The data monitoring module 10 is a software module. The data monitoring module 10 receives an acknowledgement of the text file from the transmission control module 8, then receives a corresponding text file from the data storage device 9 at predetermined time intervals on the basis of the acknowledgement, and outputs the text file to a subsequent data interpretation module 12. Since the data monitoring module 10 accesses the data storage device 9 at the predetermined time intervals, it is not necessary to activate a service execution module 14 described below for every request. Thus, efficiency of the entire processing can be improved as compared to a case in which the data monitoring module 10 accesses the data storage device 9 every time a text file is received.

A service execution module storage device 13 is a recording device for recording all or part of content of the service execution module 14 that is required for performing the processing requested from the mobile phone 2. A hard disc drive is used as the service execution module storage device 13 in this embodiment. The service execution module storage device 13 outputs all or part of the recorded content of the service execution module 14 upon a request from the data interpretation module 12.

The data interpretation module 12 is a software module. The data interpretation module 12 receives the text file held in the data storage device 9 from the data monitoring module 10 and analyzes the text file. The data interpretation module 12 interprets the requested processing and the parameters required for performing the processing from the analysis. The data interpretation module 12 loads all or part of corresponding content of the service execution module 14 from the service execution module storage device 13 on the basis of the analysis results and activates the corresponding content of the service execution module 14 on the basis of the parameters from the analysis results.

The service execution module 14 is a software module and performs the processing requested from the mobile phone 2 on the basis of the parameters received from the data interpretation module 12. In this embodiment, the service execution module 14 includes an Internet access control module 16 and a printer module 17. The Internet access control module 16 includes a data communication unit for connecting to the Internet 7 and processes data communication, a control module for controlling the data communication unit, and a driver module. The Internet access control module 16 accesses the Internet 7 using the URL received from the data interpretation module 12 and obtains content to be printed. The printer module 17 activates the printer 4 in accordance with the parameters received from the data interpretation module 12 and the content received from the Internet access control module 16 and then prints the content requested from the mobile phone 2.

In this embodiment with the arrangement described above, the transmission control module 8 functions as a text file obtaining unit for obtaining the text file from the mobile phone 2, which is a terminal device, and the data interpretation module 12 functions as an analyzing unit for analyzing the text file obtained by the text file obtaining unit to interpret the processing requested from the terminal device and the parameters required for performing the processing in the text file. The service execution module 14 functions as a service execution unit for performing the processing requested from the terminal device, in accordance with the analysis results by the analyzing unit.

With the arrangement described above, in the printing system 1, control of the mobile phone 2 by the user allows the data preparation module 5 in the mobile phone 2 to create the predetermined format of a text file including descriptions of processing requested to the server 3 and parameters required for performing the processing. Then, the text file is transmitted to the server 3.

In the server 3, the text file is temporarily held in the data storage device 9. Then, the data monitoring module 10 accesses the data storage device 9 at predetermined time intervals to read and transfer the text file to the data interpretation module 12. The processing requested from the mobile phone 2 and the parameters required for performing the processing are interpreted by the analysis of the text file by the data interpretation module 12. Access from the service execution module storage device 13 allows content of the service execution module 14 corresponding to the processing to be prepared. Then, the parameters required for performing the processing are set to launch the corresponding content of the service execution module 14. Thus, the Internet access control module 16 in the service execution module 14 accesses the Internet 7.

In the printing system 1, content to be printed is obtained by accessing the Internet 7 and the printer 4 is activated by the printer module 17 to print the content.

Accordingly, in the printing system 1, the simple arrangement in which file transfer protocols are installed on both the mobile phone 2 and the server 3 enables the mobile phone 2, which is a terminal device, to request the server 3 to perform processing. Consequently, desired processing can be requested by a terminal device with a limited processing capacity, a limited memory resource, and the like.

More specifically, a file transfer protocol is the most basic protocol in data communication. The file transfer protocol can be used for any data transmission, regardless of being wired or wireless. In this embodiment, requested processing and parameters required for performing the processing represented by the form of a text file are reported to the server 3 and the server 3 analyzes the text file to interpret the processing and the parameters required for performing the processing. Accordingly, all that is needed between the server 3 and the mobile phone 2 is transferring of the text file between them. Thus, if the mobile phone 2 and the server 3 are provided only with file transfer protocols, which are basic protocols, the mobile phone 2 is capable of requesting the server 3 to perform various types of processing and the server 3 is capable of performing the requested processing.

Accordingly, in this embodiment, it is possible for a terminal device with a limited processing capacity, a limited memory resource, and the like to request the server 3 to perform processing for printing.

With the arrangement described above, a terminal device outputs a processing request in the form of a text file including descriptions of requested processing and parameters required for performing the processing., and the processing request in the form of a text file is received by a data processing apparatus to be processed. Thus, various types of processing can be requested from a terminal device with a limited processing capacity, a limited memory resource, and the like. More specifically, even if a complicated program, that is, a heavy protocol is not installed on a terminal device, a minimal function of transferring a file enables the terminal device to request processing using a text file. Consequently, for example, if a transmission path is changed, a system merely needs a minor change.

The mobile phone 2 functioning as a terminal device includes the text file creation unit for creating a text file including descriptions of processing requested to the server 3 functioning as an external data processing apparatus and parameters required for performing the processing, in accordance with operation by the user, and the text file providing unit for providing the text file to the server 3. Since the text file providing unit provides the processing request in the form of a text file to the server 3, a terminal device with a limited processing capacity, a limited memory resource, and the like is capable of requesting the server 3 to perform processing for printing.

The server 3 includes a text file obtaining unit for obtaining a text file supplied from the mobile phone 2, an analyzing unit for analyzing the text file obtained by the text file obtaining unit to interpret processing requested from the terminal device and parameters required for performing the processing in the text file, and a service execution unit for performing the processing requested from the terminal device in accordance with the analysis results by the analyzing unit. Thus, the processing request in the form of a text file sent from the terminal device enables the server 3 to perform the processing requested from the terminal device.

Although a mobile phone, functioning as a terminal device, requests various types of processing in the embodiment described above, the present invention is not limited to this embodiment. The terminal device according to the present invention may be any apparatus, such as a television set, a video camera, a video cassette recorder, a game device, a computer, a printer, a copying machine, a facsimile machine, a digital camera, an audio unit, or a set-top box, in which a file is transferred between the terminal device and an external data processing apparatus.

Although the data preparation module 5, the data monitoring module 10, and the data interpretation module 12 are software modules in the embodiment described above, the present invention is not limited to this embodiment. These modules may be completely or partly replaced with hardware. Also, some of the modules may be integrated with other modules.

Although, in the embodiment described above, the text file is transferred based on Bluetooth, which is one type of wireless communication, the present invention is not limited to this embodiment. The present invention is widely applicable to cases in which a text file is transferred, for example, via wireless communication such as IEEE 802.11b, via wire communication, such as Ethernet (registered trademark), a universal serial bus (USB), or IEEE 1394, via optical communication such as infrared rays, and via a recording medium, such as semiconductor memory or a flexible disc.

Although a computer, functioning as a server, is requested to perform various types of processing in the embodiment described above, the present invention is not limited to this embodiment. The present invention is widely applicable to cases in which a set-top box is requested from a terminal device in a home network to perform processing and the like.

Although hard disc drives are used as the data storage device 9 and the service execution module storage device 13 in the embodiment described above, the present invention is not limited to this embodiment. A hard disc drive may be shared as the data storage device 9 and the service execution module storage device 13. Also, various recording media and read/write devices, such as semiconductor memory, a flexible disc, a magnetic-optical disc device, and an optical disc device, may be used as the data storage device 9 and the service execution module storage device 13 instead of the hard disc drive. For real-time processing for a request from the terminal device, the data storage device 9, which is such a high-capacity recording unit, may be omitted. When the service execution module 14 is arranged by recording firmware such as a driver or the like in read only memory, the service execution module storage device 13 may also be omitted as necessary.

Although content to be printed is obtained via the Internet in the embodiment described above, the present invention is not limited to this embodiment. Content to be printed may be obtained from a mobile phone. Such content corresponds to an image and text obtained via the Internet, an image and text obtained from electronic mail, a text input by key operation, an image obtained by an imaging function of a mobile phone having an imaging function, and the like. For a request to print such content obtained from a mobile phone, a file for the content is transferred to a server as an attached file or as a text file for the request including file association.

Although a processing request is supplied as a normal text file whose extension is represented by “.TXT” in the embodiment described above, the present invention is not limited to this embodiment. A processing request may be supplied, for example, as a tagged text file in which requested processing and each parameter are delimited by tags.

Although printing is requested by a terminal device in the embodiment described above, the present invention is not limited to this embodiment. The present invention is widely applicable to cases in which various types of processing such as transferring electronic mail are requested.

As described above, according to the present invention, a terminal device outputs a processing request in the form of a text file including descriptions of requested processing and parameters required for performing the processing, and the processing request in the form of a text file is received by a data processing apparatus to be processed. Thus, various types of processing can be requested from a terminal device with a limited processing capacity, a limited memory resource, and the like.

What is claimed is:

1. A data processing apparatus comprising:
text file obtaining means for obtaining a text file supplied from a terminal device;
analyzing means for analyzing the text file; and
service execution means for performing processing requested from the terminal device, in accordance with the analysis results by the analyzing means.

2. A data processing apparatus according to claim 1, wherein the analyzing means analyzes the text file to interpret details of the processing and parameters required for performing the processing.

3. A data processing apparatus according to claim 1, wherein the terminal device requests the data processing apparatus to activate a printer for printing.

4. A terminal device comprising:
text file creation means for creating a text file including a description of processing requested to an external data processing apparatus, in accordance with operation by a user and
text file providing means for providing the text file to the external data processing apparatus.

5. A terminal device according to claim 4, wherein the text file includes descriptions of the processing and parameters required for performing the processing.

6. The terminal device according to claim 4, wherein the terminal device requests the external data processing apparatus to activate a printer for printing.

7. A data processing system comprising a terminal device and a data processing apparatus for performing processing requested from the terminal device,
wherein the terminal device sends a text file including a description of requested processing to the data processing apparatus, and
wherein the data processing apparatus receives the text file from the terminal device and performs the processing written in the text file.

8. A data processing system according to claim 7, wherein the terminal device sends details of the requested processing and parameters required for performing the processing to the data processing apparatus.
